(19) United States
(12) Patent Application Publication
(10) Pub. No.: US 2026/0369257 A1
(43) Pub. Date: Nov. 19, 2026

(54) PROJECTION DEVICE AND PROJECTION SYSTEM

(71) Applicant: SEIKO EPSON CORPORATION, Tokyo (JP)

(72) Inventor: Ippei KUROTA, MATSUMOTO-SHI (JP)

(21) Appl. No.: 19/676,264

(22) Filed: May 13, 2026

(30) Foreign Application Priority Data
May 14, 2025 (JP) 2025-080968

(51) Int. Cl. G10K 11/16; G03B 21/14; G03B 21/16

(52) U.S. Cl. CPC G10K 11/161; G03B 21/145; G03B 21/16

(57) ABSTRACT

A projection device of the present disclosure includes a projection device main body provided with an intake and exhaust port and a sound absorbing member configured to be connected to the intake and exhaust port of the projection device main body, wherein the sound absorbing member includes a first cylindrical section having an air chamber facing the intake and exhaust port and a second cylindrical section that is provided on an opposite side of the first cylindrical section than the intake and exhaust port and that has a throat chamber having a cross-sectional area smaller than that of the air chamber.

The present application is based on, and claims priority from JP Application Serial Number 2025-080968, filed May 14, 2025, the disclosure of which is hereby incorporated by reference herein in its entirety.

### BACKGROUND

### 1. Technical Field

The present disclosure relates to a projection device and a projection system.

### 2. Related Art

The projector disclosed in JP-A-2023-109303 includes a lattice-shaped intake and exhaust port provided on a side surface of an outer housing. In this projector, air is caused to flow in from the intake and exhaust port by driving a fan provided in the intake and exhaust port.

However, in the projector, there is a concern that noise including driving sound of the fan leaking from the intake and exhaust port and driving sound inside the projector becomes noisy.

### SUMMARY

In order to solve the above-described problem, according to one aspect of the present disclosure, a projection device includes a projection device main body having an outer housing provided with an intake and exhaust port and a sound absorbing member configured to be connected to the intake and exhaust port of the projection device main body, wherein the sound absorbing member includes a first cylindrical section having an air chamber facing the intake and exhaust port and a second cylindrical section that is provided on an opposite side of the first cylindrical section than the intake and exhaust port and that has a throat chamber having a cross-sectional area smaller than that of the air chamber.

According to one aspect of the present disclosure, a projection system includes a projection device having an outer housing provided with an intake and exhaust port and a holding member that holds the projection device, wherein the holding member includes a holding section main body that holds the projection device and a sound absorbing member provided on the holding section main body and configured to be connected to the intake and exhaust port and the sound absorbing member includes a first cylindrical section including an air chamber facing the intake and exhaust port and a second cylindrical section that is provided on an opposite side of the first cylindrical section than the intake and exhaust port and that includes a throat chamber having a cross-sectional area smaller than that of the air chamber.

### BRIEF DESCRIPTION OF THE DRAWINGS

FIG. 1 is a perspective view illustrating an appearance of a projector according to a first embodiment.

FIG. 2 is a cross-sectional view taken along line II-II in FIG. 1.

FIG. 3 is a perspective view illustrating an appearance of a projection system according to a second embodiment.

FIG. 4 is a cross-sectional view taken along line IV-IV in FIG. 3.

FIG. 5 is a perspective view illustrating an appearance of a projection system according to a third embodiment.

FIG. 6 is a cross-sectional view of a sound absorbing member according to a modification.

### DESCRIPTION OF EMBODIMENTS

### FIRST EMBODIMENT

Hereinafter, a first embodiment of the present disclosure will be described with reference to the drawings.

In the following drawings, the scale of dimensions may be different depending on the components in order to make the components easy to see. In the present embodiment, a projector is illustrated as an example of a projection device.

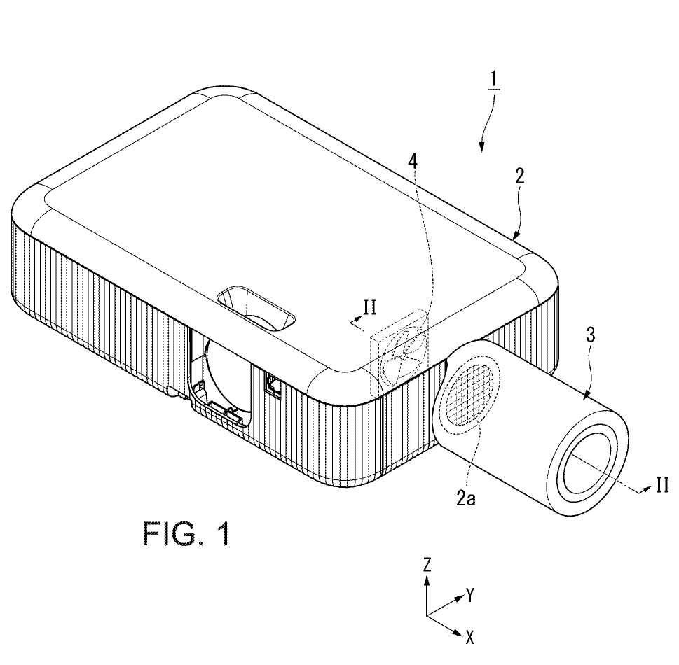

FIG. 1 is a perspective view illustrating an appearance of a projector 1 according to the present embodiment.

A projector 1 according to the present embodiment includes a projector main body 2 and a sound absorbing member 3, as illustrated in FIG. 1. The projector 1 according to the present embodiment corresponds to an example of a "projection device" according to the present disclosure, and the projector main body 2 according to the present embodiment corresponds to an example of a "projection device main body" according to the present disclosure.

The projector 1 projects an image on a screen by emitting image light from the projector main body 2 toward a projected surface such as a screen. The projector main body 2 includes an exhaust port 2a that discharges air warmed by a component accommodated inside. The exhaust port 2a according to the present embodiment corresponds to an example of an "intake and exhaust port" according to the present disclosure. The intake and exhaust port according to the present disclosure functions as either one of an intake port and an exhaust port, and does not include one opening serving as both the intake port and the exhaust port. In the present embodiment, the projector main body 2 also includes an intake port (not illustrated) as an intake and exhaust port for taking in cooling air for cooling a component accommodated inside.

In the description of the present embodiment, in a state where the projector 1 is placed on a placement surface such as a table, an axis along a left-right direction of the projector main body 2 is defined as an X-axis, an axis along a depth direction of the projector main body 2 is defined as a Y-axis, and an axis along a height direction of the projector main body 2 is defined as a Z-axis. That is, when viewed from a viewer of a projection image on the screen, the left-right direction corresponds to an X-axis direction, the depth direction corresponds to a Y-axis direction, and a vertical direction corresponds to a Z-axis direction.

The projector main body 2 includes an exhaust fan 4 for exhausting air inside the projector main body 2 from the exhaust port 2a. The exhaust fan 4 is provided in the vicinity of the exhaust port 2a or at a position facing the exhaust port 2a. As the exhaust fan 4, for example, an axial flow fan, a centrifugal fan, a sirocco fan, or the like can be used. Therefore, there is a concern that driving sound of the exhaust fan 4 leaks to outside the projector main body 2 via the exhaust port 2a.

In contrast, the projector 1 according to the present embodiment includes the sound absorbing member 3 that uses a Helmholtz structure to absorb driving sound of the exhaust fan 4 leaking from the exhaust port 2a.

To be specific, the sound absorbing member 3 is provided on the projector main body 2 so as to face the exhaust port 2a. The sound absorbing member 3 is connected to the exhaust port 2a in a state of abutting on the exhaust port 2a or in a state of being close to the exhaust port 2a with a slight gap. The sound absorbing member 3 also functions as a duct member that circulates exhaust gas K discharged from the exhaust port 2a.

The sound absorbing member 3 is detachably fitted to, for example, a circular groove provided around the exhaust port 2a of the projector main body 2. The sound absorbing member 3 may be attachable to and detachable from a side plate of the projector main body 2 via a hook member (not illustrated).

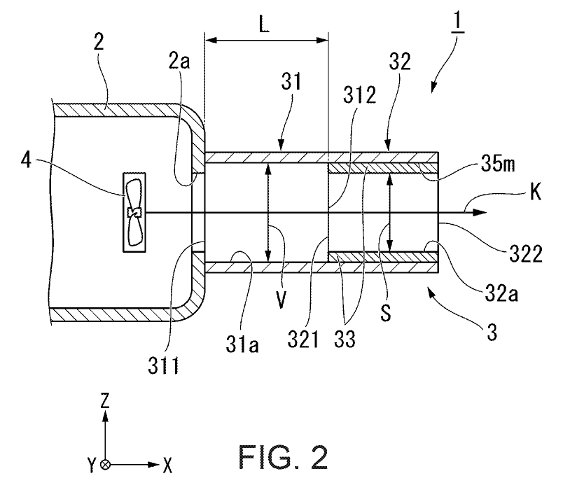

FIG. 2 is a cross-sectional view taken along line II-II in FIG. 1.

As illustrated in FIG. 2, the sound absorbing member 3 includes a first cylindrical section 31, a second cylindrical section 32, and a sound absorbing material 33. The first cylindrical section 31 and the second cylindrical section 32 are, for example, tunnel-shaped members made of metal plate or plastic. In a case of the present embodiment, the first cylindrical section 31 and the second cylindrical section 32 are formed as an integrally molded article, and the first cylindrical section 31 and the second cylindrical section 32 are formed of one pipe having the same inner diameter. The first cylindrical section 31 and the second cylindrical section 32 may be formed as separate bodies, that is, by connecting two pipes.

The first cylindrical section 31 includes an air chamber 31a facing the exhaust port 2a. The air chamber 31a is a space that is formed by a through hole of the first cylindrical section 31 and that extends in a left-right direction X, and the air chamber 31 includes an inlet side opening 311 on an exhaust port 2a side and an outlet side opening 312 on an opposite side of the exhaust port 2a. The air chamber 31a has a circular cross-section in a YZ plane orthogonal to an extension direction, and has the same cross-section along the extension direction.

The inlet side opening 311 of the air chamber 31a is larger than the exhaust port 2a. That is, a cross-sectional area of the air chamber 31a is larger than an opening area of the exhaust port 2a. Although the exhaust port 2a is illustrated as one opening in FIG. 2 for simplification of the drawing, the exhaust port 2a may be configured by a plurality of openings. When the exhaust port 2a is formed of a plurality of openings, an opening area of the exhaust port 2a corresponds to an area of a region including the outermost shape obtained by connecting the outermost shapes of the plurality of openings.

According to this configuration, the air chamber 31a can efficiently take in the exhaust gas K discharged from the exhaust port 2a. Therefore, even when the sound absorbing member 3 is provided, the projector 1 can minimize the influence on the exhaust performance at the exhaust port 2a.

The second cylindrical section 32 is provided on an opposite side of the first cylindrical section 31 from the exhaust port 2a, and includes a throat chamber 32a communicating with the air chamber 31a. The sound absorbing material 33 is provided by being attached to an inner surface 35m of the second cylindrical section 32, and surrounds the throat chamber 32a. Examples of the material of the sound absorbing material 33 include urethane foam, polyethylene foam, sponge, wood, and the like.

The throat chamber 32a is a space that is surrounded by the cylindrical sound absorbing material 33 and that extends in the left-right direction X, and the throat chamber 32a includes a throat inlet 321 on an air chamber 31a side and a throat outlet 322 on an opposite side of the air chamber 31a. The throat chamber 32a has a circular cross-section in the YZ plane orthogonal to an extension direction, similarly to the air chamber 31a, and has the same cross-section along the extension direction. An inner diameter of the throat chamber 32a is smaller than an inner diameter of the first cylindrical section 31 constituting the air chamber 31a by a thickness of the sound absorbing material 33 attached to the inner surface 35m of the second cylindrical section 32. Therefore, a cross-sectional area of the throat chamber 32a is smaller than a cross-sectional area of the air chamber 31a.

As described above, in the sound absorbing member 3 according to the present embodiment, a cross-sectional area of the throat chamber 32a is smaller than a cross-sectional area of the air chamber 31a, and thus it is possible to obtain an effect of absorbing sound incident from the air chamber 31a to the throat chamber 32a using the Helmholtz structure.

In the sound absorbing member 3 according to the present embodiment, the sound absorbing material 33 is attached to the inner surface 35m of the second cylindrical section 32, and thus the throat chamber 32a is formed by the sound absorbing material 33. Therefore, the sound absorbing member 3 according to the present embodiment can improve the sound absorption performance as compared with a throat chamber in which a cross-sectional area is made smaller than that of the air chamber 31a by narrowing an inner diameter of the second cylindrical section 32 without providing the sound absorbing material 33.

Since the sound absorbing member 3 according to the present embodiment allows the exhaust gas K discharged from the exhaust port 2a to flow, there is a concern that wind noise is generated at the throat outlet 322 of the throat chamber 32a. In contrast, in the sound absorbing member 3 according to the present embodiment, the throat chamber 32a is formed by attaching the sound absorbing material 33 to the inner surface 35m of the second cylindrical section 32, and thus the sound absorption performance of the throat chamber 32a can be further enhanced, and the generation of wind noise at the throat outlet 322 can be favorably suppressed by the sound absorbing material 33.

Here, the sound absorption performance obtained by the Helmholtz structure of the sound absorbing member 3, that is, the frequency at which the sound absorbing member 3 can absorb sound can be defined by the formula F=c/2π√(S/LV). In this formula, S corresponds to a cross-sectional area of the throat chamber 32a, L corresponds to a length of the throat chamber 32a, V corresponds to a volume of the air chamber 31a, and c corresponds to a speed of sound.

The sound absorbing member 3 is designed by setting the parameters of the above-described formula so as to satisfy the sound absorption performance required in the projector 1. In this manner, the sound absorbing member 3 having a desired sound absorption performance can be formed.

The throat outlet 322 of the throat chamber 32a has a size equal to or larger than an opening area of the exhaust port 2a.

Here, a case where the throat outlet 322 is smaller than the exhaust port 2a is considered. In a case where the throat outlet 322 is smaller than the exhaust port 2a as described above, a cross-sectional area of the throat outlet 322 is smaller than an opening area of the exhaust port 2a, and thus an exhaust amount per unit time of the throat outlet 322 is smaller than an exhaust amount per unit time of the exhaust port 2a. Therefore, when the throat outlet 322 is smaller than the exhaust port 2a, the exhaust efficiency may be reduced by providing the sound absorbing member 3.

In contrast, in a case of the present embodiment, a size of the throat outlet 322 is equal to or larger than a size of the exhaust port 2a, and thus a cross-sectional area of the throat outlet 322 is equal to or larger than an opening area of the exhaust port 2a. Therefore, an exhaust amount of the throat outlet 322 per unit time is equal to or larger than an exhaust amount of the exhaust port 2a. Therefore, according to the projector 1 according to the present embodiment, it is possible to suppress the decrease in the exhaust efficiency of the exhaust port 2a even in a case of providing the sound absorbing member 3.

The projector 1 according to the present embodiment includes the projector main body 2 provided with the exhaust port 2a, and the sound absorbing member 3 connectable to the exhaust port 2a of the projector main body 2. The sound absorbing member 3 includes the first cylindrical section 31 having the air chamber 31a facing the exhaust port 2a, and the second cylindrical section 32 provided on an opposite side of the exhaust port 2a of the first cylindrical section 31 and having the throat chamber 32a having a cross-sectional area smaller than that of the air chamber 31a.

In the projector main body 2, there is a concern that driving sound of the exhaust fan 4 leaks from the exhaust port 2a. In contrast, according to the projector 1 according to the present embodiment, the sound absorbing member 3 including the Helmholtz structure is arranged on the exhaust port 2a, and thus noise leaking from the exhaust port 2a can be absorbed. Therefore, the projector 1 according to the present embodiment can suppress noise due to the exhaust port 2a.

In the projector 1 according to the present embodiment, a cross-sectional area of the air chamber 31a is larger than a cross-sectional area of the exhaust port 2a, a cross-sectional area of the throat chamber 32a is smaller than a cross-sectional area of the air chamber 31a, and the throat outlet 322 of the throat chamber 32a is equal to or larger in size than the exhaust port 2a.

According to the projector 1 according to the present embodiment, since the sound absorbing member 3 has the exhaust performance equal to or higher than that of the exhaust port 2a, it is possible to suppress the sound absorbing member 3 from reducing the exhaust efficiency at the exhaust port 2a. Therefore, it is possible to provide the projector 1 that suppresses noise from the exhaust port 2a without affecting the exhaust efficiency of the exhaust port 2a.

### SECOND EMBODIMENT

Hereinafter, a second embodiment of the present disclosure will be described. In the first embodiment, a projection device using the projector 1 alone is taken as an example, but in the second embodiment, a floor-mounted projection system in which a projector is held by a cabinet as a holding member will be described as an example.

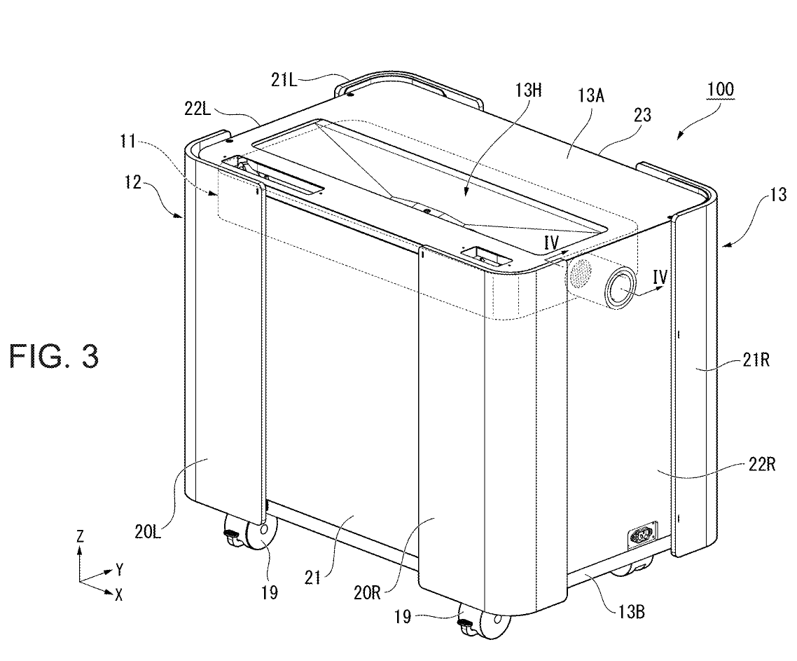

FIG. 3 is a perspective view illustrating an appearance of a projection system 100 according to the present embodiment. In FIG. 3, the same reference symbols are given to the same components as those in the drawings used in the first embodiment.

As illustrated in FIG. 3, the projection system 100 according to the present embodiment includes a projector 11 and a cabinet 12. The projector 11 emits image light toward a projected surface such as a screen. The cabinet 12 holds the projector 11 in a state of being accommodated therein. The cabinet 12 includes a cabinet main body 13 and a sound absorbing member 130. The cabinet main body 13 is a hollow box-shaped member, and can accommodate the projector 11 in an internal space thereof. The cabinet 12 according to the present embodiment corresponds to an example of a "holding member" according to the present disclosure, and the cabinet main body 13 according to the present embodiment corresponds to an example of a "holding section main body" according to the present disclosure.

In the description of the present embodiment, in a state where the cabinet 12 is placed on a floor, an axis along a left-right direction of the cabinet 12 is defined as an X-axis, an axis along a depth direction of the cabinet 12 is defined as a Y-axis, and an axis along a height direction of the cabinet 12 is defined as a Z-axis. That is, when viewed from a viewer, the left-right direction corresponds to an X-axis direction, the depth direction corresponds to a Y-axis direction, and a vertical direction corresponds to a Z-axis direction. In the following description, a surface of each member on a near side as viewed from a viewer may be referred to as a front surface, and a surface of each member on a far side as viewed from the viewer may be referred to as a rear surface.

An opening section 13H for emitting image light emitted from the projector 11 to an external space is provided in an upper plate 13A of the cabinet main body 13. The projector 11 according to the present embodiment is an ultra-short throw reflective projector. A type of the projector 11 is not limited to the ultra-short throw reflective projector. Image light emitted from the projector 11 is emitted obliquely upward (toward a +Y side and a +Z side) on a far side in FIG. 3 through the opening section 13H.

Casters 19 are provided at four corner sections of the bottom plate 13B of the cabinet main body 13. These allow a user of the projector 11 to easily move the projection system 100 to a desired location.

The front surface of the cabinet main body 13 is constituted by a pair of front plates 20R and 20L and a front cover 21. The front plates 20R and 20L extend in the vertical direction on right and left sides of the front surface of the cabinet main body 13, respectively. The front cover 21 is arranged between the pair of front plates 20R and 20L. Although not illustrated in detail, the front cover 21 is formed of a metal plate including a large number of holes and a fabric having excellent air permeability. By this, sound emitted from the projector 11 is released to an external space of the cabinet 12 through the front cover 21.

The rear surface of the cabinet main body 13 is constituted by a pair of rear plates 21R and 21L and a rear cover 23. The rear plates 21R and 21L extend in the vertical direction on right and left sides of the rear surface of the cabinet main body 13, respectively. The rear cover 23 is arranged between the pair of rear plates 21R and 21L. Although not illustrated in detail, the rear cover 23 is formed of a metal plate including a large number of holes and a fabric having excellent air permeability. By this, sound emitted from the projector 11 is released to an external space of the cabinet 12 through the rear cover 23.

A right side surface of the cabinet main body 13 is constituted by the front plate 20R, the rear plate 21R, and a right side plate 22R arranged between the front plate 20R and the rear plate 21R.

A left side surface of the cabinet main body 13 is constituted by the front plate 20L, the rear plate 21L, and a left side plate 22L arranged between the front plate 20L and the rear plate 21L.

The rear plates 21R and 21L extend in the vertical direction on right and left sides of the rear surface of the cabinet main body 13, respectively. In a case where the cabinet main body 13 is configured to be portable by handles (not illustrated) formed on the right side plate 22R and the left side plate 22L, a configuration without the casters 19 can be adopted if necessary.

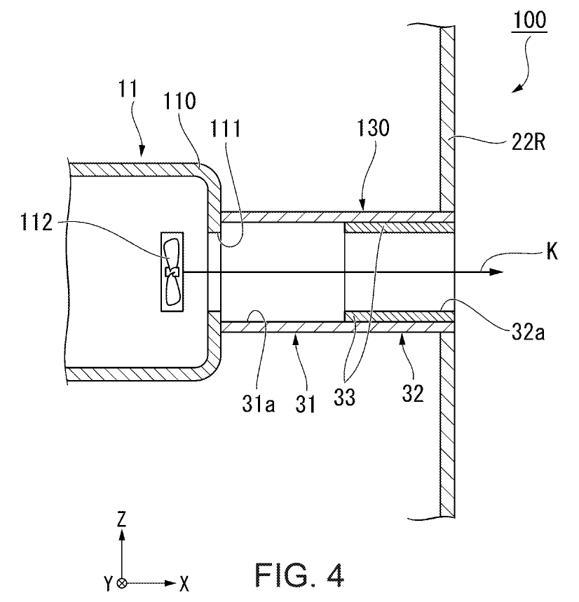

FIG. 4 is a cross-sectional view taken along line IV-IV in FIG. 3.

As illustrated in FIG. 4, the projector 11 includes an outer housing 110 that accommodates a component therein. The outer housing 110 is provided with an exhaust port 111 that discharges air warmed by a component accommodated inside. The exhaust port 111 according to the present embodiment corresponds to an example of the "intake and exhaust port" according to the present disclosure. In FIG. 4, the exhaust port 111 is illustrated as one opening for simplification of the drawing. The outer housing 110 is provided with an intake port (not illustrated) as an intake and exhaust port for taking in cooling air for cooling a component accommodated inside.

The projector 11 includes an exhaust fan 112 for exhausting air inside the outer housing 110 from the exhaust port 111. The exhaust fan 112 is provided in the vicinity of the exhaust port 111 or at a position facing the exhaust port 111. As the exhaust fan 112, for example, an axial flow fan, a centrifugal fan, a sirocco fan, or the like can be used.

In the projection system 100 according to the present embodiment, the sound absorbing member 130 is arranged on the right side plate 22R of the cabinet main body 13. The sound absorbing member 130 absorbs driving sound of the exhaust fan 112 leaking from the exhaust port 111.

To be specific, the sound absorbing member 130 is provided on the right side plate 22R so as to face the exhaust port 111 of the outer housing 110 when the projector 11 is accommodated in the cabinet main body 13. The sound absorbing member 130 is detachably connected to the exhaust port 111 in a state of abutting on the exhaust port 111 or in a state of being close to the exhaust port 111 with a slight gap. The sound absorbing member 130 also functions as a duct member that circulates the exhaust gas K discharged from the exhaust port 111.

The sound absorbing member 130 includes the same configuration as the sound absorbing member 3 of the first embodiment. That is, the sound absorbing member 130 includes the first cylindrical section 31 including the air chamber 31a, the second cylindrical section 32 including the throat chamber 32a, and the sound absorbing material 33 surrounding the throat chamber 32a.

According to the projection system 100 according to the present embodiment, the sound absorbing member 130 including the Helmholtz structure is arranged on the exhaust port 111, and thus noise leaking from the exhaust port 111 can be absorbed. Therefore, it is possible to suppress noise due to the exhaust port 111 of the projector 11.

The projection system 100 according to the present embodiment includes the projector 11, which includes the outer housing 110 provided with the exhaust port 111, and the cabinet 12, which holds the projector 11. The cabinet 12 includes the cabinet main body 13 that holds the projector 11, and the sound absorbing member 130 that is provided on the cabinet main body 13 and can be connected to the exhaust port 111. The sound absorbing member 130 includes the first cylindrical section 31 including the air chamber 31a facing the exhaust port 111, and the second cylindrical section 32 provided on an opposite side of the exhaust port 111 of the first cylindrical section 31 and including the throat chamber 32a having a cross-sectional area smaller than that of the air chamber 31a.

According to the projection system 100 according to the present embodiment, the sound absorbing member 130 including the Helmholtz structure is arranged on the exhaust port 111, and thus noise leaking from the exhaust port 111 can be absorbed. Therefore, it is possible to provide a floor-mounted projection system in which noise caused by exhaust sound of the projector 11 is suppressed.

### THIRD EMBODIMENT

Hereinafter, a third embodiment of the present disclosure will be described. In the second embodiment, an example of a floor-mounted projection system was described. In contrast, in the present embodiment, an example of a wall-mounted projection system will be described.

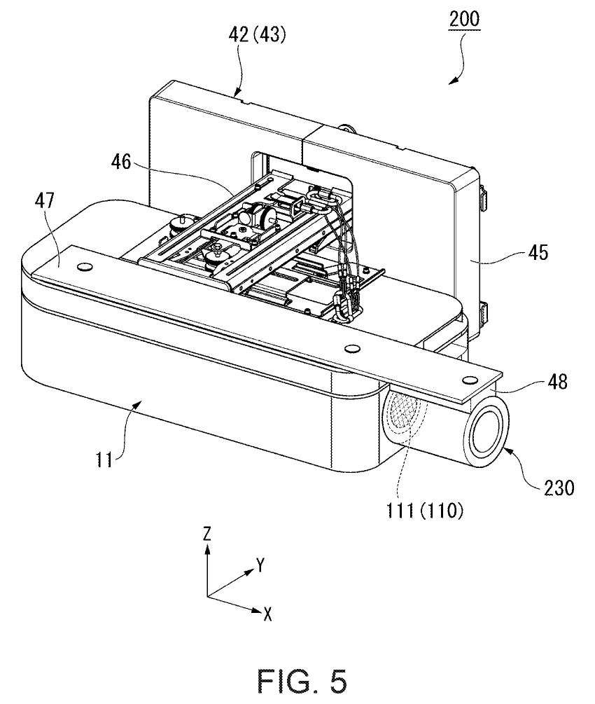

FIG. 5 is a perspective view illustrating an appearance of a projection system 200 according to the present embodiment. In FIG. 5, the same reference symbols are given to the same components as those in the drawings used in the above-described embodiments.

The projection system 200 according to the present embodiment includes the projector 11 and a hanging bracket 42, as illustrated in FIG. 5. The hanging bracket 42 includes a hanging bracket main body 43 and a sound absorbing member 230. The hanging bracket 42 according to the present embodiment corresponds to an example of a "holding member" according to the present disclosure, and the hanging bracket main body 43 according to the present embodiment corresponds to an example of a "holding section main body" according to the present disclosure.

The hanging bracket main body 43 includes a wall fixator 45, a hanging section 46, and a metal plate 47. The wall fixator 45 is formed of a member for fixing the projection system 200 to a wall. The hanging section 46 extends in a horizontal direction with respect to the wall fixator 45, and the projector 11 hangs down from it. The metal plate 47 is fixed to the hanging section 46.

The sound absorbing member 230 is arranged at a position facing the exhaust port 111 of the outer housing 110 of the projector 11. The sound absorbing member 230 is attached to one end side of the metal plate 47 of the hanging bracket 42 via a holding member 48. The sound absorbing member 230 is arranged at a position facing the exhaust port 111 in a state where the projector 11 is attached to the hanging bracket 42. According to this configuration, it is possible to easily perform positioning of the sound absorbing member 230 with respect to the projector 11. The sound absorbing member 230 and the exhaust port 111 may be separated from each other or may be in contact with each other.

The sound absorbing member 230 according to the present embodiment includes the same configuration as the sound absorbing member 3 of the first embodiment and the sound absorbing member 130 of the second embodiment.

According to the projection system 200 according to the present embodiment, the sound absorbing member 230 including the Helmholtz structure is arranged on the exhaust port 111, and thus noise leaking from the exhaust port 111 can be absorbed. Therefore, it is possible to suppress noise due to the exhaust port 111 of the projector 11.

As described above, also in the present embodiment, it is possible to provide a wall-mounted projection system in which noise caused by exhaust sound of the projector 11 is suppressed.

The technical scope of the present disclosure is not limited to the above-described embodiment, and various modifications can be made without departing from the spirit of the present disclosure.

For example, in the sound absorbing member 3 of the first embodiment, a case where the air chamber 31a has the same cross-section along the extension direction is exemplified, but it is also possible to adopt a shape in which a cross-sectional area of an air chamber is different along the extension direction. Although the same applies to the second and third embodiments, the following description will be made by taking a modification of the first embodiment as an example.

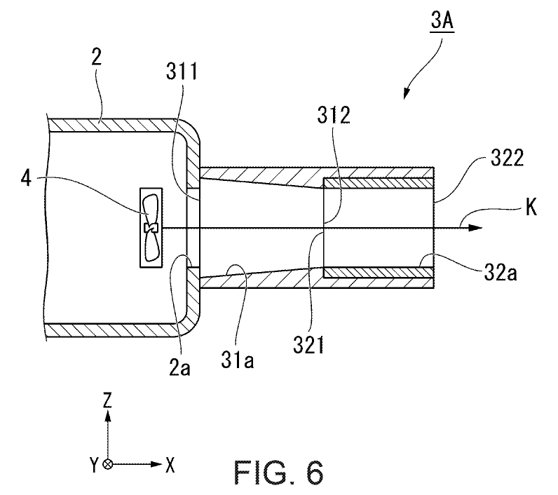

FIG. 6 is a cross-sectional view of a sound absorbing member 3A according to a modification. In FIG. 6, the same reference symbols are given to the same members as those in the first embodiment.

As illustrated in FIG. 6, in the sound absorbing member 3A according to the present modification, a cross-sectional area of the air chamber 31a gradually decreases from the inlet side opening 311 toward the outlet side opening 312. That is, a cross-sectional area of the air chamber 31a gradually decreases toward the throat chamber 32a. The outlet side opening 312 has a size equivalent to that of the throat inlet 321 of the throat chamber 32a.

By forming the air chamber 31a so that an inner diameter thereof is reduced in a tapered manner, the outlet side opening 312 of the air chamber 31a and the throat inlet 321 of the throat chamber 32a are connected in a continuous state.

According to the sound absorbing member 3A according to the present modification, an inner diameter of the air chamber 31a gradually decreases toward the throat chamber 32a, and the air chamber 31a and the throat chamber 32a are continuously connected, so that exhaust gas K can flow smoothly from the air chamber 31a into the throat chamber 32a. Therefore, turbulence of the exhaust gas K at a connection section between the air chamber 31a and the throat chamber 32a is suppressed, and the performance of the sound absorbing member 3A as an exhaust duct can be further enhanced.

The outlet side opening 312 may not be equal to the throat inlet 321 of the throat chamber 32a, and may have a size equal to or larger than that of the throat inlet 321. Even when the outlet side opening 312 has a size equal to or larger than that of the throat inlet 321, an inner diameter of the air chamber 31a gradually decreases toward the throat chamber 32a, and therefore, the effect of allowing the exhaust gas K to flow smoothly can be obtained as compared with a case where an inner diameter of the air chamber 31a is constant in the extension direction.

Although the sound absorbing members 3, 130, and 230 of the embodiments described above are all arranged corresponding to the exhaust ports and absorb noise leaking from the exhaust ports, the sound absorbing member of the present disclosure can also absorb noise leaking from an intake port for taking cooling air into the projector as the intake and exhaust port.

In the above-described embodiment, the sound absorbing members 3, 130, and 230 all include the sound absorbing material 33 surrounding the throat chamber 32a, but the sound absorbing material 33 may be omitted if necessary. In a case where the sound absorbing material 33 is omitted, an inner diameter of the second cylindrical section 32 may be reduced by a thickness of the sound absorbing material 33, so that a cross-sectional area of the throat chamber 32a is smaller than a cross-sectional area of the air chamber 31a.

Although the wall-mounted projection system is exemplified in the third embodiment, the present disclosure may be applied to a projection system of a type hung from a ceiling. In this case, a ceiling fixator may be provided instead of the wall fixator of the hanging bracket of the third embodiment.

In addition, the specific description of the material, the number, the arrangement, and the like of each component of the projector and the projection system is not limited to the embodiment described above, and can be changed as appropriate.

### Summary of present disclosure

Hereinafter, a summary of the present disclosure is appended.

### First note

A projection device includes
a projection device main body provided with an intake and exhaust port and
a sound absorbing member configured to be connected to the intake and exhaust port of the projection device main body,
wherein
the sound absorbing member includes
   a first cylindrical section having an air chamber facing the intake and exhaust port and
   a second cylindrical section that is provided on an opposite side of the first cylindrical section than the intake and exhaust port and that has a throat chamber having a cross-sectional area smaller than that of the air chamber.

According to the projection device including this configuration, the sound absorbing member including the Helmholtz structure is arranged on the intake and exhaust port, and thus noise leaking from the intake and exhaust port can be absorbed. Therefore, according to this configuration, noise due to the exhaust port can be suppressed.

### Second note

The projection device according to first note, wherein
the air chamber includes an inlet side opening facing the intake and exhaust port and
the inlet side opening of the air chamber is larger than the intake and exhaust port.

According to this configuration, the air chamber can efficiently take in exhaust gas discharged from the intake and exhaust port. Therefore, even when the sound absorbing member is provided, the influence on the exhaust performance in the intake and exhaust port can be minimized.

### Third note

The projection device according to second note, wherein
the throat chamber includes a throat outlet opposite the air chamber and
the throat outlet has a same size as the intake and exhaust port.

According to this configuration, since the sound absorbing member has the exhaust performance equal to or higher than that of the intake and exhaust port, it is possible to suppress the sound absorbing member from decreasing the exhaust efficiency at the intake and exhaust port. Therefore, it is possible to provide a projection device that suppresses noise of the intake and exhaust port without affecting the exhaust efficiency of the intake and exhaust port.

### Fourth note

The projection device according to any one of first note to third note, wherein
the air chamber includes an inlet side opening facing the intake and exhaust port and an outlet side opening facing the throat chamber,
a cross-sectional area of the air chamber gradually decreases from the inlet side opening toward the outlet side opening, and
the outlet side opening has a size equal to or larger than that of a throat inlet of the throat chamber.

According to this configuration, an inner diameter of the air chamber gradually decreases toward the throat chamber, and the air chamber and the throat chamber are smoothly connected, allowing air to flow smoothly from the air chamber into the throat chamber. Therefore, it is possible to suppress the turbulence of airflow at a connection section between the air chamber and the throat chamber, and to further improve the performance of the sound absorbing member as a duct.

### Fifth note

The projection device according to any one of first note to fourth note, wherein
the sound absorbing member is provided on an inner surface of the second cylindrical section and the projection device further includes a sound absorbing material surrounding the throat chamber.

According to this configuration, the sound absorption performance of the throat chamber can be further enhanced, and the generation of wind noise at the throat outlet can be favorably suppressed by the sound absorbing material.

### Sixth note

A projection system includes
a projection device having an outer housing provided with an intake and exhaust port and
a holding member that holds the projection device, wherein
the holding member includes
   a holding section main body that holds the projection device and
   a sound absorbing member provided on the holding section main body and configured to be connected to the intake and exhaust port and the sound absorbing member includes
      a first cylindrical section including an air chamber facing the intake and exhaust port and
      a second cylindrical section that is provided on an opposite side of the first cylindrical section than the intake and exhaust port and that includes a throat chamber having a cross-sectional area smaller than that of the air chamber.

According to the projection system including this configuration, the sound absorbing member including the Helmholtz structure is arranged on the intake and exhaust port, and thus noise leaking from the intake and exhaust port can be absorbed. Therefore, it is possible to provide a projection system in which noise caused by exhaust sound of a projection device is suppressed.

### Seventh note

The projection system according to sixth note, wherein
the holding member is a cabinet that accommodates the projection device.

According to this configuration, it is possible to provide a floor-mounted projection system in which noise caused by exhaust sound of a projection device is suppressed.

### Eighth note

The projection system according to sixth note, wherein
the holding member is a hanging bracket that hangs the projection device.

According to this configuration, it is possible to provide a hanging type projection system in which noise caused by exhaust sound of a projection device is suppressed.

What is claimed is:

1. A projection device comprising:
a projection device main body provided with an intake and exhaust port and
a sound absorbing member configured to be connected to the intake and exhaust port of the projection device main body, wherein
the sound absorbing member includes
a first cylindrical section having an air chamber facing the intake and exhaust port and
a second cylindrical section that is provided on an opposite side of the first cylindrical section than the intake and exhaust port and that has a throat chamber having a cross-sectional area smaller than that of the air chamber.

2. The projection device according to claim 1, wherein
the air chamber includes an inlet side opening facing the intake and exhaust port and
the inlet side opening of the air chamber is larger than the intake and exhaust port.

3. The projection device according to claim 2, wherein
the throat chamber includes a throat outlet opposite the air chamber and
the throat outlet has a same size as the intake and exhaust port.

4. The projection device according to claim 1, wherein
the air chamber includes an inlet side opening facing the intake and exhaust port and an outlet side opening facing the throat chamber,
a cross-sectional area of the air chamber gradually decreases from the inlet side opening toward the outlet side opening, and
the outlet side opening has a size equal to or larger than that of a throat inlet of the throat chamber.

5. The projection device according to claim 1, wherein
the sound absorbing member is provided on an inner surface of the second cylindrical section and the projection device further includes a sound absorbing material surrounding the throat chamber.

6. A projection system comprising:
a projection device having an outer housing provided with an intake and exhaust port and
a holding member that holds the projection device, wherein
the holding member includes
a holding section main body that holds the projection device and
a sound absorbing member provided on the holding section main body and configured to be connected to the intake and exhaust port and
the sound absorbing member includes
a first cylindrical section including an air chamber facing the intake and exhaust port and
a second cylindrical section that is provided on an opposite side of the first cylindrical section than the intake and exhaust port and that includes a throat chamber having a cross-sectional area smaller than that of the air chamber.

7. The projection system according to claim 6, wherein
the holding member is a cabinet that accommodates the projection device.

8. The projection system according to claim 6, wherein
the holding member is a hanging bracket that hangs the projection device.
